(19) United States
(12) Patent Application Publication
(10) Pub. No.: US 2017/0083621 A1
(43) Pub. Date: Mar. 23, 2017

(54) SYSTEMS AND METHODS FOR PROVIDING MUSIC RECOMMENDATIONS

(71) Applicant: Limited Liability Company Mail.Ru, Moscow (RU)

(72) Inventors: Dmitry Yur'evich BUGAYCHENKO, Saint-Petersburg (RU); Vladimir Mikhaylovich KOCHETKOV, Saint-Petersburg (RU)

(21) Appl. No.: 15/190,208

(22) Filed: Jun. 23, 2016

Related U.S. Application Data
(63) Continuation of application No. PCT/RU2013/001205, filed on Dec. 30, 2013.

(51) Int. Cl. G06F 17/30; H04N 21/466; H04N 21/45; H04L 29/08

(52) U.S. Cl. CPC G06F 17/30761; H04L 67/306; H04N 21/4668; H04N 21/4532; H04L 67/10; G06F 17/30958

(57) ABSTRACT

A computerized system and an associated computer-implemented method for the analysis of user activity and preparation of the data for a music recommender in a social network. The history of actions is analyzed in multiple dimensions in order to mine collaborative correlations, temporal correlations and overall ranking. The results of the analysis are exported in a form of a taste graph, which is then used to generate on-line music recommendations. The taste graph captures relations between different entities pertaining to music (users, tracks, artists, etc.) and it consists of the following main parts: user preferences, track similarities, artist similarities, artists' works and demography profiles. Each part of the taste graph is created using a separate algorithm. The recommendations are generated based on the composed stochastic graph structure using a random walk algorithm.

### BACKGROUND OF THE INVENTION

Field of the Invention

The disclosed embodiments relate in general to the field of computer technology and in particular to systems and methods for the analysis of user activity and preparation of the data for a music recommender in a social network.

Description of the Related Art

Conventional music recommender systems typically produce a list of recommendations for the user based on the analysis of user's past behavior or of the related musical content. For example, the music recommender system may suggest a similar track to a one liked by the user. However, as would be appreciated by persons of skill in the art, in a music service, there are many ways to extract other data, which are useful for generating music recommendations for users, especially in a social networking context. Playback history, user's profile and metadata of the played tracks can give an estimate of relations between different entities: users, tracks, artists, etc. The challenge however remains of combining all these diverse data into a unified music recommendation framework.

Accordingly, there is a need for a music recommendation framework that would integrate data from different sources and generate music recommendations based on these diverse data. Thus, new and improved systems and methods for providing music recommendations are needed.

### SUMMARY OF THE INVENTION

The inventive methodology is directed to methods and systems that substantially obviate one or more of the above and other problems associated with conventional techniques for providing music recommendations to users.

In accordance with one aspect of the embodiments described herein, there is provided a computer-implemented method for making a recommendation to a user, the method being performed in connection with a computerized system incorporating a central processing unit and a memory, the computer-implemented method involving: using the central processing unit to compose a stochastic graph structure based on collaborative correlations, content information and social data associated with the user, the stochastic graph structure comprising a plurality of edges; using the central processing unit to analyze the composed stochastic graph structure; and using the central processing unit to construct a recommendation for the user based on the analyzed stochastic graph structure.

In one or more embodiments, at least one of the collaborative correlations, content information and social data associated with the user is obtained from a social networking platform.

In one or more embodiments, the method further comprises personalizing the recommendation for the user and transmitting the personalized recommendation to the user.

In one or more embodiments, the recommendation comprises an identity of a musical content recommended to the user.

In one or more embodiments, the plurality of edges of the stochastic graph structure comprises edges of a plurality of edge types and wherein the plurality of edge types comprises a user edge type, an author edge type and a track edge type.

In one or more embodiments, the composed stochastic graph structure is analyzed using a random walk algorithm, wherein the random walk is performed between the plurality of edges of the stochastic graph structure.

In one or more embodiments, the method further comprises filtering out at least some of the plurality of edges of the stochastic graph structure.

In one or more embodiments, the filtering is performed based on a subgraph density.

In one or more embodiments, a graphics processing unit (GPU) may be used instead of the aforesaid central processing unit to perform one or more steps of the computer-implemented method described above.

In accordance with another aspect of the embodiments described herein, there is provided a non-transitory computer-readable medium embodying a set of computer-readable instructions, which, when executed in connection with a computerized system incorporating a central processing unit and a memory, cause the computerized system to perform a computer-implemented method for making a recommendation to a user, the computer-implemented method involving: using the central processing unit to compose a stochastic graph structure based on collaborative correlations, content information and social data associated with the user, the stochastic graph structure comprising a plurality of edges; using the central processing unit to analyze the composed stochastic graph structure; and using the central processing unit to construct a recommendation for the user based on the analyzed stochastic graph structure.

In one or more embodiments, at least one of the collaborative correlations, content information and social data associated with the user is obtained from a social networking platform.

In one or more embodiments, the method further comprises personalizing the recommendation for the user and transmitting the personalized recommendation to the user.

In one or more embodiments, the recommendation comprises an identity of a musical content recommended to the user.

In one or more embodiments, the plurality of edges of the stochastic graph structure comprises edges of a plurality of edge types and wherein the plurality of edge types comprises a user edge type, an author edge type and a track edge type.

In one or more embodiments, the composed stochastic graph structure is analyzed using a random walk algorithm, wherein the random walk is performed between the plurality of edges of the stochastic graph structure.

In one or more embodiments, the method further comprises filtering out at least some of the plurality of edges of the stochastic graph structure.

In one or more embodiments, the filtering is performed based on a subgraph density.

In one or more embodiments, a graphics processing unit (GPU) may be used instead of the aforesaid central processing unit to perform one or more steps of the computer-implemented method described above.

In accordance with yet another aspect of the embodiments described herein, there is provided a computerized system incorporating a central processing unit and a memory, the memory comprising instruction for: using the central processing unit to compose a stochastic graph structure based on collaborative correlations, content information and social data associated with the user, the stochastic graph structure comprising a plurality of edges; using the central processing unit to analyze the composed stochastic graph structure; and using the central processing unit to construct a recommendation for the user based on the analyzed stochastic graph structure.

In one or more embodiments, at least one of the collaborative correlations, content information and social data associated with the user is obtained from a social networking platform.

In one or more embodiments, the memory further comprises instructions for personalizing the recommendation for the user and transmitting the personalized recommendation to the user.

In one or more embodiments, the recommendation comprises an identity of a musical content recommended to the user.

In one or more embodiments, the plurality of edges of the stochastic graph structure comprises edges of a plurality of edge types and wherein the plurality of edge types comprises a user edge type, an author edge type and a track edge type.

In one or more embodiments, the composed stochastic graph structure is analyzed using a random walk algorithm, wherein the random walk is performed between the plurality of edges of the stochastic graph structure.

In one or more embodiments, the memory further comprises instructions for filtering out at least some of the plurality of edges of the stochastic graph structure.

In one or more embodiments, the filtering is performed based on a subgraph density.

In one or more embodiments, a graphics processing unit (GPU) may be used instead of the aforesaid central processing unit to perform one or more steps of the computer-implemented method described above.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a partly stochastic taste graph.

FIG. 2 illustrates an exemplary diagram of balanced artist-track edge weights.

FIG. 3 illustrates a distributed system for the analysis of user activity and preparation of recommendation for the user in a social network.

FIG. 4 is a block diagram that illustrates an exemplary embodiment of a computer system upon which the described method for the analysis of user activity and preparation of the data for a music recommender in a social network may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

As it would be clear to persons of ordinary skill in the art, in order to provide high quality music recommendations, there is a need to consider different types of information: collaborative correlations, content information, context, demographic information of the user, and the like. Orchestrating multiple recommenders can address this challenge, but at a cost of increased computation complexity (architectural and deployment complexity increases to). Thus, again, there is a need for a common framework capable of incorporating and evaluating data of different types.

Thus, in accordance with one or more embodiments described herein, there are provided systems and methods for analyzing the user activity and preparing the data for a music recommender in a social network environment. Specifically, the described systems and methods can be used to construct a taste graph in a general-purpose social network. The bulk of the information used by the described system and method is the history of the user activity, such as history of user's activity in a social network. This information allows the music recommendation system to estimate the connection between the user and the item vertices, and to extract collaborative correlations between the items (tracks and artists). In addition, the described techniques enable analysis of a user profile and extraction of metadata from music files. In one or more embodiments, after the aforesaid metadata extraction, a number of post-processing phases are performed.

Taste graph captures this knowledge to solve different recommender tasks. The mentioned objects with relations are used as vertices and edges of the graph: a user likes an artist, which is similar to another artist, who recorded a certain track, and each relation can be weighted by a quantitative metric, based on statistics analysis. Such edges construct numerous chains of edges between a user and unknown tracks.

### 1. Taste Graph Construction

In one or more embodiments, in order to combine all the information mined from a computer system, such as a social networking platform, including collaborative correlations, content information and social data, a stochastic graph structure is used. Subsequently, this graph is analyzed using various algorithms in order to construct recommendations and personalize the output for the user. Formally, the taste graph is an oriented weighted labeled graph capturing all the information associated with the user mined from the computer system. Formally, the taste graph G can be defined as a tuple (V, θ, T_{V}, τ_{V}, E, T_{E}, τ_{E}, R, ω), where:

T_{V} is a finite non-empty set of vertex types and τ_{V}: V→T_{V} is a mapping function matching each vertex to its type;

θεV is a zero balancing vertex used to compensate impact of vertexes with small amount of outgoing edges;

T_{E} is a finite non-empty set of edge types and τₑ: E→T_{E} is a mapping function matching each edge to its type;

R:E→V×V is a function matching each edge to its start vertex and end vertex;

ω: E→[0, 1] is a weight function matching each edge to its weight.

In one or more embodiments, taste graph G satisfies the following condition:

$$∀ v ∈ V , t ∈ {T}_{E} \text{:} {\sum }_{e ∈ out ( v , t )} ω ( e ) = 1. \qquad ( 1 )$$

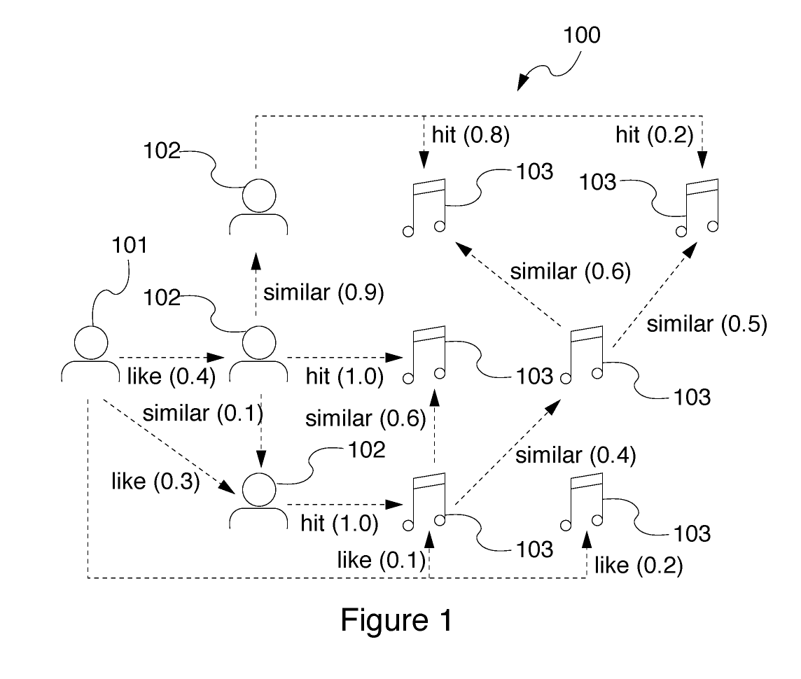

Graph satisfying the aforesaid condition (1) is called a partly stochastic graph. An exemplary embodiment of the partly stochastic graph 100 is illustrated in FIG. 1. The graph 100 includes user node 101, artist nodes 102 and track nodes 103. The links (relationships) between the aforesaid nodes of the graph are labeled as “like” indicating that the user likes a particular artist or track, “similar” indicating that particular tracks or artists are similar and “hit” indicating popular tracks of the artist. The corresponding non-balanced transition probabilities for the random walk algorithm are also shown as the numbers in the parenthesis.

In one or more embodiments, in order to obtain a fully stochastic graph, a balancing function β: T_{V}×T_{E}→[0, 1] is used. In one or more embodiments, the balancing function satisfies the following condition:

$$∀ {t}_{v} ∈ {T}_{V} \text{:} {\sum }_{{t}_{e} ∈ {T}_{E}} β ( {t}_{v} , {t}_{e} ) = 1. \qquad ( 2 )$$

Based on the aforesaid balancing function β, it is possible to define a balanced weight function ω_{β}: E→[0,1] as ω_{β}(e)=ω(e)*β(T_{V}(first(R(e))),τₑ(e)). Based on the above definition, it is clear that after the weight function ω_{β}, is applied, the graph G becomes a stochastic graph:

$$∀ v ∈ V \text{:} {\sum }_{{t}_{e} ∈ {T}_{E} , e ∈ out ( v , {t}_{e} )} {ω}_{β} ( e ) = 1. \qquad ( 3 )$$

In one or more embodiments, empty θ vertex is important in situations where the graph node has substantially smaller number of adjacent edges than an average for its type. According to the formula (3), the empty θ vertex gets an unfair acceleration. For such vertices, an extra edge is added to the θ vertex, the weight of which is defined as the approximate sum of the lacking edge weights, if such edges were present. As would be appreciated by persons of ordinary skill in the art, the exact algorithm to determine this weight is different for each tεT_{E}.

In one or more embodiments, the balancing function β is used to manage the impact of different factors on the overall result. This function can be changed at runtime without the need to recreate the graph, which increases the flexibility of the described recommendation system.

In one or more embodiments, the emphasis on different data types and the partial stochastic is placed for practical reasons because this allows different portions of the taste graph to be constructed independently and then combined together. In the description below, it is assumed that after determining the weights of edges, normalization and balancing will be performed. In the described scenario, T_{V} consists of the following parts: users, tracks, artists and demographic groups. Hence T_{E} is:

1.1 User Preferences;

1.2 Demography profiles;

1.3 Track similarities;

1.4 Artist similarities; and

1.5 Artists' works.

Next, the methodology for constructing each portion of the graph and the analysis techniques for its edge weighting will be described in detail.

### 1.1 User Preferences

In one or more embodiments, the user preferences include two components, namely the preference for artists and tracks, which are determined based on the number of the respective item playbacks by the user. However, in practice, a user who have repeatedly listened to a specific artist or track may have already lost his or her interest in it, but the number of past plays invariably puts it into the top of the recommendations list. Thus, the described recommendation system uses exponential moving average to update the user preferences:

pref₀(u,i)=plays₀(u,i)

pref₀(u,i)=α·playsₜ(u,i)+(1−α)·prefₜ₋₁(u,i) (4)

where playsₜ(u, i) is the number of artist or track i plays by user u within a t-th month. In one or more embodiments, no further action is being performed with respect to the preferences, except applying the balancing function β in order to manage the impact of similarities with different types.

### 1.2 Demography Profiles

In one or more embodiments, the user demographic profile is used to avoid the cold start problem for new users. When pref (u)={i|pref (u, i)≠0} does not contain enough elements, the system uses demographic group vertex as a starting point for random walks. Demographic groups U₁, . . . Uₖ are disjoint subsets of users U, formed from user profiles with the same or similar values of user demographic characteristics (such as gender, age, region).

$${d}_{i}^{p} = {\sum }_{u ∈ {U}_{p}} pref ( u , i ) \qquad ( 5 )$$

In one or more embodiments, in order to extract user's demographic identity from a particular demographic group, the system computes deviations of the top group preferences from the system-wide top swt, where swtᵢ=Σ_{uεU}prefs(u,i)

$$prefs ( {U}_{p} ) = \frac{{top}_{n} ( {d}^{p} )}{{‖ {top}_{n} ( {d}^{p} ) ‖}_{1}} - \frac{{top}_{n} ( swt )}{{‖ {top}_{n} ( swt ) ‖}_{1}} \qquad ( 6 )$$

The profiles described above do not have incoming edges within the graph, therefore as soon as the user gathers enough preferences for independent recommendations, these profiles do not affect the random walks.

### 1.3 Track Similarities

The standard way for determining similarities involves calculating the collaborative correlations between items based on user ratings. Such methods are based on some similarity measure (usually variations of the Pearson correlation coefficient, see C. Desrosiers and G. Karypis. A comprehensive survey of neighborhood-based recommendation methods. Recommender Systems Handbook, pages 107-144, 2011, incorporated herein by reference). In one or more embodiments, this approach is used to calculate the similarity metric between hundreds of thousands or even millions of music tracks, each represented by a ratings vector. In one or more embodiments, the system uses algorithms for distributed computation of similarity of items, such as jobs in the library Apache Mahout, well known to persons of ordinary skill in the art, which reduces the computational time to a reasonable value. However, for large music catalogs and large numbers of users, implementing the described system requires a powerful computer cluster for timely updating the statistics. In one or more embodiments, track temporal correlations are used instead of the similarity measure. In addition, due to the greater diversity of artists in similarities, a matrix of temporal correlations has been chosen.

Let p^{u}_{i,j} be the number of tracks i and j listenings by the user u within a particular time period. Denoted by p_{i,j} is the sum of p^{u}_{i,j} of all users. The value of p_{i,j} reflects how well the tracks i and j are listened together, but this value alone is not sufficient to arrive at a conclusion of whether the tracks i and j are similar. One needs to subtract the popularity of the similar track in order to obtain pure temporal correlations t_{i,j}:

$${t}_{i , j} = \frac{{p}_{i , j}}{{\sum }_{j = 1}^{N} {p}_{i , j}} - {b}_{j}^{i} , \qquad ( 7 )$$

where bⁱⱼ is a baseline of the track j adopted for similarity with track i.

If

$${p}_{j} = {\sum }_{i = 1}^{N} {p}_{i , j}$$

and Tⁱ={k|p_{i,k}≠0} then

$${b}_{j}^{i} = \frac{{p}_{j}}{{\sum }_{j = 1}^{N} {p}_{j} \cdot {1}_{{T}^{i}} ( j )} \qquad ( 8 )$$

Thus, for calculating similar tracks, the system is configured to normalize rows of P={p_{i,j}}^{N}_{i,j=1} and B={pⱼ·1_{T}_{ⁱ}(j)}^{N}_{i,j=1} and compute the temporal correlation matrix T={t_{i,j=1}}^{N}=N−B.

### 1.4 Artist Similarities

As would be appreciated by persons of ordinary skill in the art, because the number of artists is substantially smaller than the number of tracks, the computing system performance is less of an issue and more complex algorithms can be used. Unlike the classical approach described in B. Sarwar, G. Karypis, J. Konstan, and J. Riedl, Item-based collaborative filtering recommendation algorithms, In Proceedings of the 10th international conference on World Wide Web, pages 285-295, ACM, 2001, incorporated herein by reference, where a distance metric between vectors of user ratings is calculated during similar items searching, the described recommendation system starts with a vector of artists' common playbacks.

In one or more embodiments, using the Artist-to-Artist input instead of the User-to-Artist one, the vectors' density can be increases by many times. This reduces an impact of outliers on the input data in relation to the found collaborative correlations. In addition, this aggregation eliminates the need to work with the high-dimension vectors. In one or more embodiments, the calculations are done in three stages:

1. Pre-filtering of triples (User, Track, PlayCount). The system filters the triples with small values of PlayCount and users with small amount of statistics. As would be appreciated by persons of ordinary skill in the art, the system needs to keep only reliable tracks. Thus, the system is configured to disregard the tracks, which do not pass filtering by density as described in section 2 below. Finally, the playbacks are grouped by artist and the number of common users is used as the initial approximation a⁰_{i,j} for artist similarity.

2. Iterative calculation of the vector similarity measure between rows of A^{k}={a^{k}_{i,j}}^{N}_{i,j=1}. The best results achieved the Euclidean distance and specifically:

$${a}_{i , j}^{k} = \frac{1}{1 + \sqrt{{\sum }_{l = 1}^{N} {( {a}_{i , l}^{k - 1} - {a}_{j , l}^{k - 1} )}^{2}}} \qquad ( 9 )$$

After each iteration, elements of the main diagonal are artificially increased for a better convergence in the following manner:

$${a}_{i , i}^{k} = α \cdot {\sum }_{i \neq j} {a}_{i , j}^{k} , \qquad ( 10 )$$

where 0<α<1.

3. Resultant similarity lists are filtered by the methods described in section 2 below.

### 1.5 Artists' Works

In one or more embodiments, the correspondence between artists and tracks is determined using a music catalog. Obviously, if the active user vertex is close to the artist vertex, it is reasonable to recommend the user the most popular tracks of this artist. But artist's works present not only a way to propagate the recommendations of similar artists on the tracks, but also a solution for the cold start problem to new tracks in a music catalog:

$${w}_{i} = b \cdot {\sum }_{u ∈ U} prefs ( u , i ) , \qquad ( 11 )$$

where b>1 is a novelty boost factor.

Comparing different artists, one can notice large variation in the size of musical works. In accordance with the rule (3), tracks of artists with large numbers of related songs will be suppressed. The system takes two steps to avoid this suppression. First, the system limits by L the number of adjacent edges with Track-Artist type. Second, for artists with small number of tracks, the system simulates existence of entry tracks with weights, which are close to being real. Simulation is achieved by adding the edge from the artist j vertex to θ balancing vertex with weight w_{θ}(j). Denoted by Wⱼ are tracks of an artist j:

$${w}_{θ} ( j ) = \vert {W}_{j} \vert \cdot {min}_{t ∈ {W}_{j}} {a}_{t} \cdot ( \frac{1}{\vert {W}_{j} \vert + 1} + \frac{1}{\vert {W}_{j} \vert + 2} + … \frac{1}{L} ) \qquad ( 12 )$$

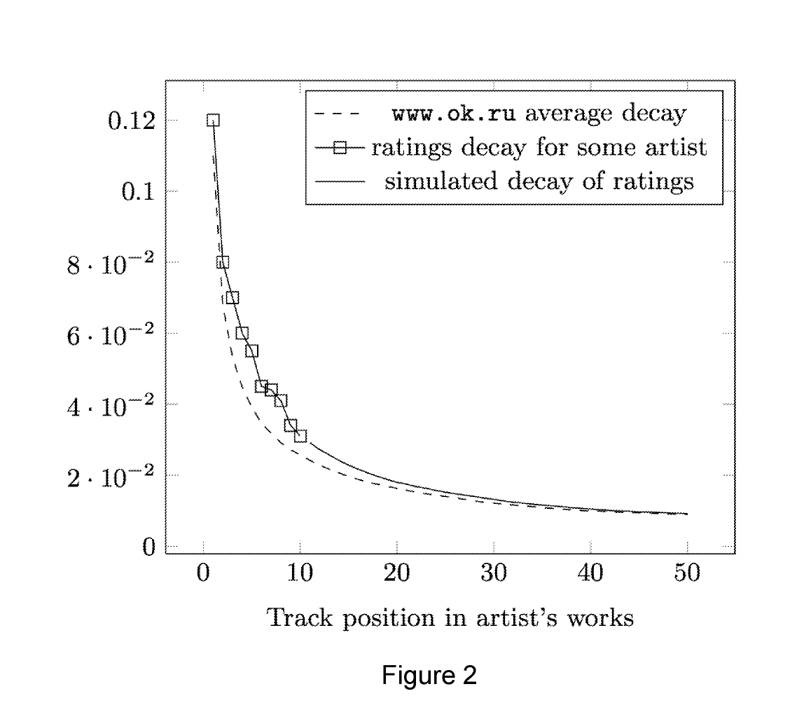

Formula (12) is a model of hyperbolic popularity decay. As shown in FIG. 2, the rating of the most popular tracks decreases in a hyperbolic manner, therefore this decay is simulated from the lower track's position to L.

### 1.6 Summary

Along with the graph structure described in herein, there are the following types of paths from the user to the tracks:

1. User→Track→Track

2. User→Artist→Track

3. User→Artist→Artist→Track

It is clear that if there is a high probability of restarting, the tracks of the second type paths will have much greater impact on the result than tracks achieved by the third type paths (for any balancing function). This fact reflects the real relationships between entities, but most likely the user is already familiar with the works of his or her favorite artists. In order to increase recommendation novelty, in one or more embodiments, the artist vertex type from T_{V} can be divided into two types: an Artist is connected with a Similar Artist who is connected with tracks. Thus, the paths in the graph become the following:

1. User→Track→Track

2. User→Artist→SimilarArtist→Track

In one or more embodiments, the difference between the aforesaid two paths can be controlled by the balancing function described above.

### 2. Similarity Filtration

The methods of outliers filtering for the lists of similar items are presented below. Filtration of similarities with insufficient statistics is close to correlation coefficient shrinkage described in Y. Koren and R. Bell. Advances in collaborative filtering. Recommender Systems Handbook, pages 145-186, 2011, which is incorporated herein by reference. Similarity between items i and j is discounted in the following manner:

$${\hat{s}}_{i , j} = \frac{{n}_{i , j} - 1}{{n}_{i , j} - 1 + λ \cdot min ( {n}_{i} , {n}_{j} )} \cdot {s}_{i , j} , \qquad ( 13 )$$

where n_{i,j} is a number of users who rated both items i and j, nₖ is a number of users who rated item k, and λ>0 is a small constant. It should be noted that in different situations, rather than the min(nᵢ,nⱼ) can be used arithmetic or geometric mean, so the selection function requires additional experiments.

In one or more embodiments, the second filter is used for filtering outliers. To detect outliers, the sum of similarity values to other items on the list is computed for each element of the list. In other words, the described system computes S^{˜}=S² where S={s_{i,j}}^{N}_{i,j=1} and filters s_{i,j} with small values of s^{˜}_{i,j}.

The third filter is used to remove similar lists containing overly diverse information. As in the case of outliers filtration, the system uses the computed similarity of a list item to other list items in terms of the subgraph density defined as:

$$D = \frac{2 \vert E \vert}{\vert V \vert ( \vert V \vert - 1 )} \qquad ( 14 )$$

To check the similarity set s(i)={j|s_{i,j}≠0)} the system computes a density Dᵢ of the G subgraph, induced by s(i) vertices. Values of Dᵢ which are too low (e.g. below a predetermined threshold) tend to indicate an unreliable list, which will have a negative impact on the resultant recommendations. Such lists are eliminated from the resulting recommendation.

After all the aforesaid filtering is completed, items with short similar lists start exerting more significant influence. In order to compensate their increased impact on the resultant recommendation, the system uses edges to zero balance vertex θ. This step simulates the presence of missing edges with weights decreasing linearly from the minimum similarity to 0.

In one or more embodiments, the described taste graph has many of the desired properties: it can include data of different types in a single model with online balancing and various types of algorithms for many tasks can be implemented. In addition, the computational complexity can be reduced for online computations and an immediate response of the recommendation system to the changes in the user behavior can be implemented. The test results that have been achieved using the described techniques are very encouraging in terms of both the increased user activity and the recommender's non-functional properties (computational efficiency, scalability and flexibility).

In one or more embodiments, introduction of singular value decomposition (SVD) latent factors in the graph reduces its size and makes possible the inclusion of the relations between users without considerable overheads. It should be further noted that the embodiments described herein are not limited to music recommendation systems. The described techniques may be applied to systems for recommending videos, graphics or other types of multimedia and other content. In addition, the described techniques are not limited to providing recommendations in connection with social networking platforms and can be used in any context when the data on user's prior activity is readily available.

### 3. Exemplary System Implementation

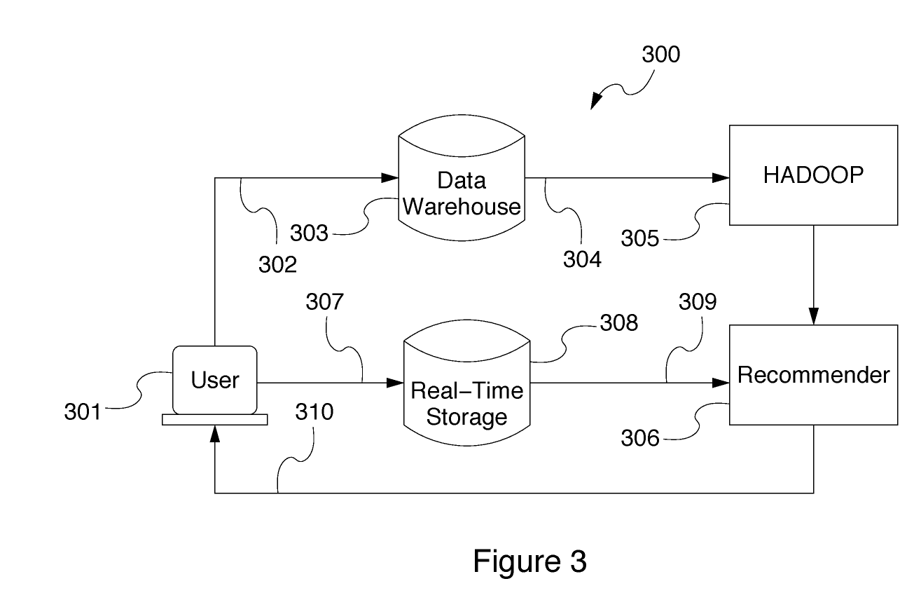

FIG. 3 illustrates a distributed system 300 for the analysis of user activity and preparation of recommendation for the user in a social network. The distributed system 300 incorporates a client system 301 directly accessible by the user. The information on the user's actions 302 is gathered on the client system 301 and is sent from the client system 301 to a data warehouse 303. In one or more embodiments, the data warehouse 303 is deployed based on a database management system. The database management system may be implemented based on any now known or later developed type of database software, such as a relational database management system, including, without limitation, MySQL, Oracle, SQL Server, DB2, SQL Anywhere, PostgreSQL, SQLite, Firebird and/or MaxDB, which are well-known to persons of skill in the art. In an alternative embodiment, a cloud-based distributed database, such as Amazon Relational Database Service (Amazon RDS), well known to persons of ordinary skill in the art, may also be used to implement the database management system used in connection with deploying the data warehouse 303. Alternatively, the information on the user activity may be gathered by a social networking system (not shown) and similarly sent to the data warehouse 303.

The data warehouse 303 performs aggregation of the user activity statistics 304 and provides it to the data mining engine 305. In one embodiment, the data mining engine 305 is implemented based on an open source platform for distributed data mining, such as Apache HADOOP, well known to persons of ordinary skill in the art. The data mining engine 305 builds the taste graph in accordance with the algorithms described above and furnishes it to the recommender 306. Selected user actions 307, such as recent playbacks and all user “likes” are also furnished by the client system 301 or the social networking system (not shown) to the real-time storage 308. Real-time ratings updates 309 are transmitted from the real-time storage 308 to the recommender 306. Finally, the recommender 306 generates the recommendations for the user based on the received information and transmits these recommendations 310 to the client system 301 or to the social networking system (not shown).

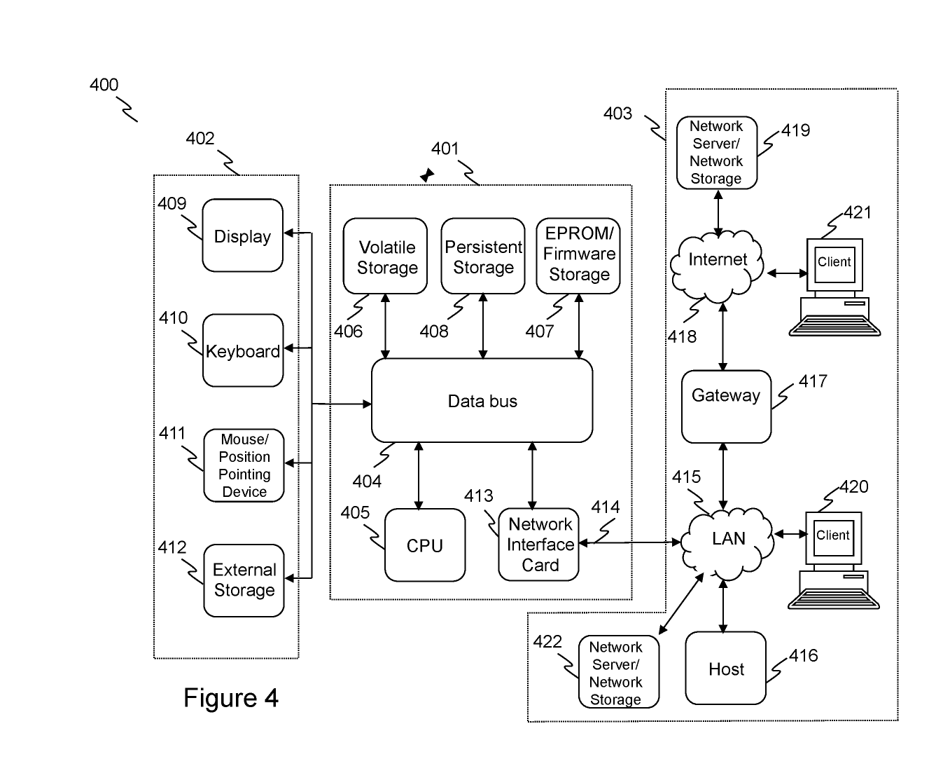

FIG. 4 is a block diagram that illustrates an exemplary embodiment of a computer system 400 upon which the described method for the analysis of user activity and preparation of the data for a music recommender in a social network may be implemented. The system 400 includes a computer platform 401, peripheral devices 402 and network resources 403.

The computer platform 401 may include a data bus 404 or other communication mechanism for communicating information across and among various parts of the computer platform 401, and a processor 405 coupled with bus 404 for processing information and performing other computational and control tasks. Computer platform 401 also includes a volatile storage 406, such as a random access memory (RAM) or other dynamic storage device, coupled to bus 404 for storing various information as well as instructions to be executed by processor 405, including the software application for proxy detection described above. The volatile storage 406 also may be used for storing temporary variables or other intermediate information during execution of instructions by processor 405. Computer platform 401 may further include a read only memory (ROM or EPROM) 407 or other static storage device coupled to bus 404 for storing static information and instructions for processor 405, such as basic input-output system (BIOS), as well as various system configuration parameters. A persistent storage device 408, such as a magnetic disk, optical disk, or solid-state flash memory device is provided and coupled to bus 404 for storing information and instructions.

Computer platform 401 may be coupled via bus 404 to a touch-sensitive display 409, such as a cathode ray tube (CRT), plasma display, or a liquid crystal display (LCD), for displaying information to a system administrator or user of the computer platform 401. An input device 410, including alphanumeric and other keys, is coupled to bus 404 for communicating information and command selections to processor 405. Another type of user input device is cursor control device 411, such as a mouse, a trackball, or cursor direction keys for communicating direction information and command selections to processor 405 and for controlling cursor movement on touch-sensitive display 409. This input device typically has two degrees of freedom in two axes, a first axis (e.g., x) and a second axis (e.g., y), that allows the device to specify positions in a plane. To detect user's gestures, the display 409 may incorporate a touchscreen interface configured to detect user's tactile events and send information on the detected events to the processor 405 via the bus 404.

An external storage device 412 may be coupled to the computer platform 401 via bus 404 to provide an extra or removable storage capacity for the computer platform 401. In an embodiment of the computer system 400, the external removable storage device 412 may be used to facilitate exchange of data with other computer systems.

The invention is related to the use of computer system 400 for implementing the techniques described herein. In an embodiment, the inventive system may reside on a machine such as computer platform 401. According to one embodiment of the invention, the techniques described herein are performed by computer platform 401 in response to processor 405 executing one or more sequences of one or more instructions contained in the volatile memory 406. Such instructions may be read into volatile memory 406 from another computer-readable medium, such as persistent storage device 408. Execution of the sequences of instructions contained in the volatile memory 406 causes processor 405 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 405 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 408. Volatile media includes dynamic memory, such as volatile storage 406.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 405 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 404. The bus 404 carries the data to the volatile storage 406, from which processor 405 retrieves and executes the instructions. The instructions received by the volatile memory 406 may optionally be stored on persistent storage device 408 either before or after execution by processor 405. The instructions may also be downloaded into the computer platform 401 via Internet using a variety of network data communication protocols well known in the art.

The computer platform 401 also includes a communication interface, such as network interface card 413 coupled to the data bus 404. Communication interface 413 provides a two-way data communication coupling to a network link 414 that is coupled to a local network 415. For example, communication interface 413 may be an integrated services digital network (ISDN) card or a modem to provide a data communication connection to a corresponding type of telephone line. As another example, communication interface 413 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 413 sends and receives electrical, electromagnetic or optical signals that carry digital data streams representing various types of information.

Network link 414 typically provides data communication through one or more networks to other network resources. For example, network link 414 may provide a connection through local network 415 to a host computer 416, or a network storage/server 422. Additionally or alternatively, the network link 414 may connect through gateway/firewall 417 to the wide-area or global network 418, such as an Internet. Thus, the computer platform 401 can access network resources located anywhere on the Internet 418, such as a remote network storage/server 419. On the other hand, the computer platform 401 may also be accessed by clients located anywhere on the local area network 415 and/or the Internet 418. The network clients 420 and 421 may themselves be implemented based on the computer platform similar to the platform 401.

Local network 415 and the Internet 418 both use electrical, electromagnetic or optical signals that carry digital data streams. The signals through the various networks and the signals on network link 414 and through communication interface 413, which carry the digital data to and from computer platform 401, are exemplary forms of carrier waves transporting the information.

Computer platform 401 can send messages and receive data, including program code, through the variety of network(s) including Internet 418 and LAN 415, network link 415 and communication interface 413. In the Internet example, when the system 401 acts as a network server, it might transmit a requested code or data for an application program running on client(s) 420 and/or 421 through the Internet 418, gateway/firewall 417, local area network 415 and communication interface 413. Similarly, it may receive code from other network resources.

The received code may be executed by processor 405 as it is received, and/or stored in persistent or volatile storage devices 408 and 406, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the computerized systems and methods for the analysis of user activity and preparation of the data for a music recommender in a social network. It is intended that the specification and examples be considered as exemplary only, with a true scope and spirit of the invention being indicated by the following claims.

What is claimed is:

1. A computer-implemented method for making a recommendation to a user, the method being performed in connection with a computerized system comprising a central processing unit and a memory, the computer-implemented method comprising:
a. using the central processing unit to compose a stochastic graph structure based on collaborative correlations, content information and social data associated with the user, the stochastic graph structure comprising a plurality of edges;
b. using the central processing unit to analyze the composed stochastic graph structure; and
c. using the central processing unit to construct a recommendation for the user based on the analyzed stochastic graph structure.

2. The computer-implemented method of claim 1, wherein at least one of the collaborative correlations, content information and social data associated with the user is obtained from a social networking platform.

3. The computer-implemented method of claim 1, further comprising personalizing the recommendation for the user and transmitting the personalized recommendation to the user.

4. The computer-implemented method of claim 1, wherein the recommendation comprises an identity of a musical content recommended to the user.

5. The computer-implemented method of claim 1, wherein the plurality of edges of the stochastic graph structure comprises edges of a plurality of edge types and wherein the plurality of edge types comprises a user edge type, an author edge type and a track edge type.

6. The computer-implemented method of claim 1, wherein the composed stochastic graph structure is analyzed using a random walk algorithm, wherein the random walk is performed between the plurality of edges of the stochastic graph structure.

7. The computer-implemented method of claim 1, further comprising filtering out at least some of the plurality of edges of the stochastic graph structure.

8. The computer-implemented method of claim 7, wherein the filtering is performed based on a subgraph density.

9. A non-transitory computer-readable medium embodying a set of computer-readable instructions, which, when executed in connection with a computerized system comprising a central processing unit and a memory, cause the computerized system to perform a computer-implemented method for making a recommendation to a user, the computer-implemented method comprising:
a. using the central processing unit to compose a stochastic graph structure based on collaborative correlations, content information and social data associated with the user, the stochastic graph structure comprising a plurality of edges;
b. using the central processing unit to analyze the composed stochastic graph structure; and
c. using the central processing unit to construct a recommendation for the user based on the analyzed stochastic graph structure.

10. The non-transitory computer-readable medium of claim 9, wherein at least one of the collaborative correlations, content information and social data associated with the user is obtained from a social networking platform.

11. The non-transitory computer-readable medium of claim 9, wherein the method further comprises personalizing the recommendation for the user and transmitting the personalized recommendation to the user.

12. The non-transitory computer-readable medium of claim 9, wherein the recommendation comprises an identity of a musical content recommended to the user.

13. The non-transitory computer-readable medium of claim 9, wherein the plurality of edges of the stochastic graph structure comprises edges of a plurality of edge types and wherein the plurality of edge types comprises a user edge type, an author edge type and a track edge type.

14. The non-transitory computer-readable medium of claim 9, wherein the composed stochastic graph structure is analyzed using a random walk algorithm, wherein the random walk is performed between the plurality of edges of the stochastic graph structure.

15. The non-transitory computer-readable medium of claim 9, wherein the method further comprises filtering out at least some of the plurality of edges of the stochastic graph structure.

16. The non-transitory computer-readable medium of claim 15, wherein the filtering is performed based on a subgraph density.

17. A computerized system comprising a central processing unit and a memory, the memory comprising instruction for:
a. using the central processing unit to compose a stochastic graph structure based on collaborative correlations, content information and social data associated with the user, the stochastic graph structure comprising a plurality of edges;
b. using the central processing unit to analyze the composed stochastic graph structure; and
c. using the central processing unit to construct a recommendation for the user based on the analyzed stochastic graph structure.

18. The computerized system of claim 17, wherein at least one of the collaborative correlations, content information and social data associated with the user is obtained from a social networking platform.

19. The computerized system of claim 17, wherein the method further comprises personalizing the recommendation for the user and transmitting the personalized recommendation to the user.

20. The computerized system of claim 17, wherein the composed stochastic graph structure is analyzed using a random walk algorithm, wherein the random walk is performed between the plurality of edges of the stochastic graph structure.
